(19) United States
(12) Patent Application Publication
(10) Pub. No.: US 2008/0118287 A1
(43) Pub. Date: May 22, 2008

(54) Optical scanning device and image forming apparatus having the same

(75) Inventors: Akihiro Masaki, Osaka (JP); Satoshi Hayano, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION

(21) Appl. No.: 11/976,895

(22) Filed: Oct. 29, 2007

(30) Foreign Application Priority Data
Oct. 31, 2006 (JP) 2006-295460

(51) Int. Cl. G03G 21/00

(52) U.S. Cl. 399/350

(57) ABSTRACT

An optical scanning device that permits the surface of an optically transparent member provided at an opening through which a light beam passes to be cleaned with an elastic cleaning member effectively without causing inconveniences such as noise and that offers high image quality has: a housing; an optical arrangement housed inside the housing and irradiating a scanned surface with a light beam; an opening through which the light beam from the optical arrangement travels toward the scanned surface; an optically transparent member provided at the opening; and an elastic cleaning member wiping the surface of the optically transparent member while being kept in pressed contact therewith, the part of the elastic cleaning member making contact with the optically transparent member being formed of a material having a higher hardness than the material of which the part of the elastic cleaning member not making contact with the optically transparent member is formed.

This application is based on Japanese Patent Application No. 2006-295460 filed on Oct. 31, 2006, the contents of which are hereby incorporated by reference.

### BACKGROUND OF THE INVENTION

1. Field of the Invention

The present invention relates to an optical scanning device incorporated in an image forming apparatus such as a copier, printer, or facsimile machine for the purpose of irradiating with a light beam (for example, laser beam) and thereby scanning the surface of an image carrier body. The present invention also relates to an electrophotographic image forming apparatus, as exemplified by copiers and printers, having such an optical scanning device.

2. Description of Related Art

In general, an optical scanning device employed in a copier, printer, or the like scans the surface of an image carrier body as exemplified by a photoconducter drum, i.e. the scanned surface, to expose the surface to light and thereby form a predetermined electrostatic latent image. In the optical scanning device, the light beam, for example laser beam, emitted from a light source is deflected in a main scanning direction by a light deflector, and is then directed toward the scanned surface by a reflecting mirror.

The optical scanning device has a housing, and has, housed inside the housing, an optical arrangement including a light source, a light deflector, a reflecting mirror, and the like for irradiating the scanned surface with a light beam. The optical scanning device also has an opening through which the light beam from the optical arrangement passes when traveling toward the scanned surface. Since it is necessary that the light beam is deflected in the main scanning direction, i.e. the direction along the axis of the photoconducter drum, the opening formed in the housing is elongated in the direction along the photoconducter drum axis.

Here, the toner fed to the photoconducter drum surface for the development of the electrostatic latent image may be scattered out of the image forming section during development, during drum rotation, or during the cleaning of the drum surface for the removal of the toner remaining thereon after the transfer of the toner image. To cope with this, in the optical scanning device, the opening through which the light beam travels toward the scanned surface is provided with an optically transparent member such as a dustproof glass plate so that the opening is kept closed. In particular in a case where the optical scanning device is disposed below the photoconducter drum, it is absolutely necessary to provide the opening with an optically transparent member.

Certainly, providing an optically transparent member at the opening through which the light beam from the optical scanning device passes helps to prevent the entry of dust such as scattered toner into the optical scanning device. The dust such as scattered toner, however, settles on the surface of the optically transparent member. Inconveniently, the settled dust may obstruct the passage of the light beam, possibly hampering the formation of an accurate electrostatic latent image on the photoconducter drum surface.

As a solution to this inconvenience, there have been proposed optical scanning devices provided with a cleaning member that cleans the surface of the optically transparent member for closing the opening serving as a passage for a light beam. An example of such optical scanning devices can bee seen in JP-A-2006-154228 (pp. 6-7, FIG. 2).

In the optical scanning device (optical scanning unit) disclosed in JP-A-2006-154228, the surface of a dust-resistance glass plate provided as an optically transparent member at an opening through which a light beam passes is cleaned by an elastic cleaning member, which is an elastic blade (rubber blade) that wipes the surface while being kept in pressed contact therewith. This prevents the light beam from being adversely affected by dust such as scattered toner, and thus permits satisfactory passage of the light beam. Disadvantageously, however, with this structure, in which the surface of an optically transparent member such as a glass plate is cleaned by an elastic cleaning member such as a rubber blade that wipes the surface while being kept in pressed contact therewith, unless the elastic cleaning member is designed carefully, inconveniences may result, such as incapability of effective cleaning of the surface of the optically transparent member and noise during cleaning.

Specifically, for example, in a case where the entire elastic cleaning member is formed of a material having a comparatively high hardness, it may occur that the elastic cleaning member cannot be kept in close contact with the surface of the optically transparent member evenly over the entire length of the elastic cleaning member, i.e. over the entire range in the main scanning direction. This makes it impossible to wipe the surface of the optically transparent member effectively with the elastic cleaning member. Inconveniently, this results in uneven cleaning, which adversely affects the passage of the light beam, leading to poor image quality.

By contrast, in a case where the entire elastic cleaning member is formed of a material having a comparatively low hardness, it can be kept in close contact with the surface of the optically transparent member evenly over the entire range in the main scanning direction. Just because the elastic cleaning member has a low hardness, however, it may occur that, at the part of the elastic cleaning member at which it makes contact with the optically transparent member, the former cannot be kept in satisfactorily pressed contact with the surface of the latter. Inconveniently, this results in the elastic cleaning member wiping the surface of the optically transparent member insufficiently, leaving dust such as scattered toner remaining thereon. This adversely affects the passage of the light beam, leading to poor image quality. Also inconvenient is that vibration may occur during cleaning, causing loud noise, and also causing displacement and deformation in and damage to the members nearby.

### SUMMARY OF THE INVENTION

In view of the inconveniences discussed above, it is an object of the present invention to provide an optical scanning device that permits the surface of an optically transparent member provided at an opening through which a light beam passes to be cleaned with an elastic cleaning member effectively without causing inconveniences such as noise and that offers high image quality. It is another object of the present invention to provide a high-performance image forming apparatus having such an optical scanning device.

To achieve the first object mentioned above, according to a first aspect of the present invention, an optical scanning device is provided with: a housing; an optical arrangement that is housed inside the housing and that irradiates a scanned surface with a light beam; an opening through which the light beam from the optical arrangement travels toward the scanned surface; an optically transparent member that is provided at the opening; and an elastic cleaning member that wipes the surface of the optically transparent member while being kept in pressed contact therewith, the part of the elastic cleaning member making contact with the optically transparent member being formed of a material having a higher hardness than the material of which the part of the elastic cleaning member not making contact with the optically transparent member is formed.

According to a second aspect of the present invention, in the optical scanning device structured as described above, the elastic cleaning member is a blade that has a rectangular shape and that has a two-layer structure such that the part of the elastic cleaning member a predetermined thickness deep from the surface at which it makes contact with the optically transparent member is formed of a material having a higher hardness than the material of which the other part of the elastic cleaning member is formed.

According to a third aspect of the present invention, in the optical scanning device structured as described above, the optically transparent member has, at the surface at which it makes contact with the elastic cleaning member, a coating film that is optically transparent, water-repellent, and oil-repellent and that provides a coefficient of friction of 0.5 or less.

To achieve the second object mentioned above, according to a fourth aspect of the present invention, an image forming apparatus has the optical scanning device according to one of the first to third aspects of the present invention.

With the structure according to the present invention, in an optical scanning device provided with: an opening through which a light beam traveling toward a scanned surface passes; an optically transparent member that is provided at the opening; and an elastic cleaning member that wipes the surface of the optically transparent member while being kept in pressed contact therewith, the part of the elastic cleaning member making contact with the optically transparent member is formed of a material having a higher hardness than the material of which the part of the elastic cleaning member not making contact with the optically transparent member is formed. Thus, at the part of the elastic cleaning member at which it makes contact with the optically transparent member, the former can be kept in satisfactorily pressed contact with the latter; in addition, the elastic cleaning member can be kept in close contact with the surface of the optically transparent member over the entire length of the former, i.e. over the entire range in the main scanning direction. This can prevent uneven cleaning, and thus prevent dust such as scattered toner from remaining, and it is possible to wipe the surface of the optically transparent member effectively. It is also possible to prevent vibration during cleaning and thereby prevent various inconveniences induced by vibration. In this way, it is possible to realize an optical scanning device that permits the surface of an optically transparent member provided at an opening through which a light beam passes to be cleaned with an elastic cleaning member effectively without causing inconveniences such as noise and that offers high image quality.

Moreover, the elastic cleaning member is a blade that has a rectangular shape and that has a two-layer structure such that the part of the elastic cleaning member a predetermined thickness deep from the surface at which it makes contact with the optically transparent member is formed of a material having a higher hardness than the material of which the other part of the elastic cleaning member is formed. This makes it comparatively easy to realize an elastic cleaning member that, at the part thereof making contact with the optically transparent member, can be kept in satisfactorily pressed contact with the optically transparent member and that can be kept in close contact with the surface of the optically transparent member over the entire range in the main scanning direction. Thus, in the cleaning of the surface of the optically transparent member, it is possible to achieve, with a simpler structure, prevention of inconveniences such as noise and effective cleaning free from uneven cleaning or remaining dust.

Moreover, the optically transparent member has, at the surface at which it makes contact with the elastic cleaning member, a coating film that is optically transparent, water-repellent, and oil-repellent and that provides a coefficient of friction of 0.5 or less. Thus, in addition to effective cleaning achieved with the elastic cleaning member, it is also possible to achieve prevention of moisture condensation on the surface of the optically transparent member. This helps to keep the surface of the optically transparent member cleaner, and thus helps to obtain higher image quality. Besides these benefits, the coating film helps to suppress vibration, and permits the elastic cleaning member to move smoothly across the surface of the optically transparent member. Thus, it is possible to achieve smooth cleaning while preventing inconveniences such as noise.

Moreover, according to the present invention, the optical scanning device described above is incorporated in an image forming apparatus. This makes it possible to realize an image forming apparatus that permits the surface of an optically transparent member provided at an opening through which a light beam from the optical scanning device passes to be cleaned with an elastic cleaning member effectively without causing inconveniences such as noise and that offers high image quality.

### BRIEF DESCRIPTION OF THE DRAWINGS

FIG. 1 is a schematic vertical sectional front view of an image forming apparatus having an optical scanning device according to the present invention;

FIG. 2 is a schematic vertical sectional front view of the optical scanning device shown in FIG. 1;

FIG. 3 is a schematic top view of the optical scanning device shown in FIG. 1;

FIG. 4 is a perspective view of the optical scanning device;

FIG. 5 is a perspective view of a part of the dustproof glass sheet around an elastic cleaning member;

FIG. 6 is a vertical sectional front view of the elastic cleaning member and the surroundings thereof;

FIG. 7 is a perspective view, like FIG. 4, of the optical scanning device, to show the cleaning mechanism in action; and

FIG. 8 is a vertical sectional front view, like FIG. 6, of the elastic cleaning member and the surroundings thereof, to show the cleaning mechanism in action.

### DETAILED DESCRIPTION OF PREFERRED EMBODIMENTS

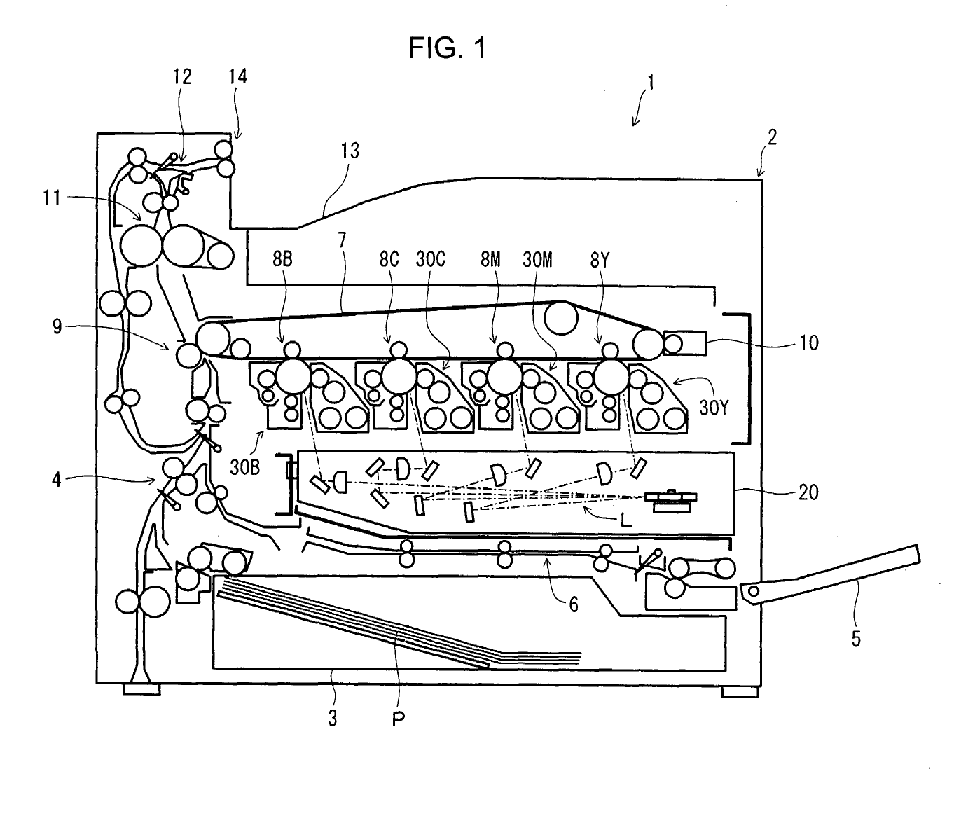

Hereinafter, an embodiment of the present invention will be described with reference to FIGS. 1 to 8. First, with regard to an image forming apparatus having an optical scanning device according to the present invention, an outline of the structure thereof will be described and, in the course of the description, how it outputs an image will also be explained. FIG. 1 is a schematic vertical sectional front view of the image forming apparatus. This image forming apparatus is capable of color printing through transfer of toner images by use of an intermediary transfer belt.

As shown in FIG. 1, the image forming apparatus 1 has a paper cassette 3 disposed inside a cabinet 2, in a bottom part thereof. Inside the paper cassette 3, a stack of unprinted, cut sheets of paper P is stored. One sheet of paper P after another is separated from the stack, and is fed out of the paper cassette 3 in a left-upward direction as seen in FIG. 1. The paper cassette 3 can be drawn out horizontally from the front face of the cabinet 2.

Inside the cabinet 2, to the left of the paper cassette 3, a first paper conveying section 4 is provided. The first paper conveying section 4 extends substantially vertically along the left side face of the cabinet 2. The first paper conveying section 4 receives the paper P fed out of the paper cassette 3, and conveys it vertically upward along the left side face of the cabinet 2 to a secondary transfer section 9.

Above the paper cassette 3, at the right side face of the cabinet 2, i.e. at the side face of the cabinet 2 opposite from the left side face thereof where the first paper conveying section 4 is provide, a hand feeding section 5 is provided. The hand feeding section 5 is for placing thereon, for example, a sheet of paper P of a different size from that stored in the paper cassette 3, a thick sheet of paper, or an OHP transparent sheet—i.e. what the user wants to feed one by one.

At the left of the hand feeding section 5, a second paper conveying section 6 is provided. The second paper conveying section 6 is located right above the paper cassette 3, and extends substantially horizontally from the hand feeding section 5 to the first paper conveying section 4 to eventually connects to the first paper conveying section 4. The second paper conveying section 6 receives the paper P or the like fed out of the hand feeding section 5, and conveys it substantially horizontally to the first paper conveying section 4.

On the other hand, the image forming apparatus 1 receives original image data from an external computer (not shown). This image data is fed to an optical scanning device 20, serving as exposure means, disposed above the second paper conveying section 6. The optical scanning device 20 emits laser beams L which are controlled according to the image data into image forming sections 30.

Above the optical scanning device 20, a total of four image forming sections 30 are provided and, further above these image forming sections 30, an intermediary transfer belt 7 is provided. The intermediary transfer belt 7 is an intermediary transfer member formed into an endless belt. The intermediary transfer belt 7 is supported by being wound around a plurality of rollers, and rotates clockwise as seen in FIG. 1 by being driven by an unillustrated driving device.

As shown in FIG. 1, the four image forming sections 30 are disposed side by side in a row in the direction of rotation of the intermediary transfer belt 7 from upstream to downstream, in a so-called tandem arrangement. The four image forming sections 30 are, from upstream, an image forming section for yellow 30Y, an image forming section for magenta 30M, an image forming section 30C for cyan, and an image forming section 30B for black. These image forming sections 30 are each supplied with developer (toner) from a corresponding developer supply container by corresponding conveying means (neither is illustrated). At this point, the suffixes “Y”, “M”, “C”, and “B” will be omitted in the following description unless such distinction is necessary.

In each of the image forming sections 30, the laser beam L emitted from the optical scanning device 20, serving as exposure means, forms an electrostatic latent image, and from this electrostatic latent image, a toner image is developed. In a primary transfer section 8 provided above the image forming sections 30, the toner image is then transferred—called primary transfer—onto the surface of the intermediary transfer belt 7. As the intermediary transfer belt 7 rotates, the toner images formed in the individual image forming sections 30 are transferred onto the intermediary transfer belt 7 one after another with predetermined timing so that, on the surface of the intermediary transfer belt 7, a color toner image is formed that has four differently colored—namely yellow, magenta, cyan, and black—toner images overlapped into one.

At a place where the intermediary transfer belt 7 meets the paper conveying path, a secondary transfer section 9 is provided. At a secondary transfer nip portion which is formed in the secondary transfer section 9, the color toner image on the surface of the intermediary transfer belt 7 is transferred onto paper P that is synchronously conveyed there.

After secondary transfer, the toner and other matter remaining on the surface of the intermediary transfer belt 7 that have settled thereon are removed and collected by a cleaning apparatus 10 for the intermediary transfer belt 7 provided with respect to the rotation direction of the intermediary transfer belt 7, on the upstream side of the image forming section for yellow 30Y.

Above the secondary transfer section 9, a fixing section 11 is provided. The paper P having an unfixed toner image formed thereon in the secondary transfer section 9 is then conveyed to the fixing section 11, where the toner image is fixed by being heated and pressed between a heating roller and a pressing roller.

Above the fixing section 11, a branching section 12 is provided. The paper P conveyed out of the fixing section 11 is, if no two-sided printing is required, then ejected from the branching section 12 to a paper ejection section 13 provided in a top part of the image forming apparatus 1.

The paper ejection slit through which the paper P is ejected from the branching section 12 to the paper ejection section 13 also acts as a switchback section 14. When two-sided printing is performed, the switchback section 14 reverses the conveying direction of the paper P ejected out of the fixing section 11. The paper P is then conveyed downward from the branching section 12b by the left side of the fixing section 11 and then by the left side of the secondary transfer section 9 so that the paper is once again conveyed through the first paper conveying section 4 to the secondary transfer section 9.

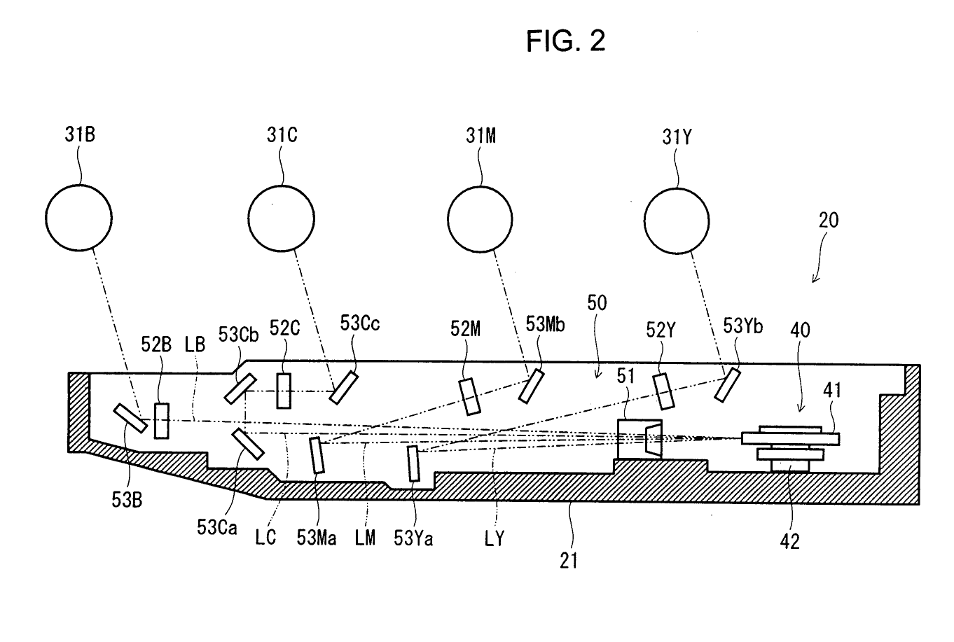

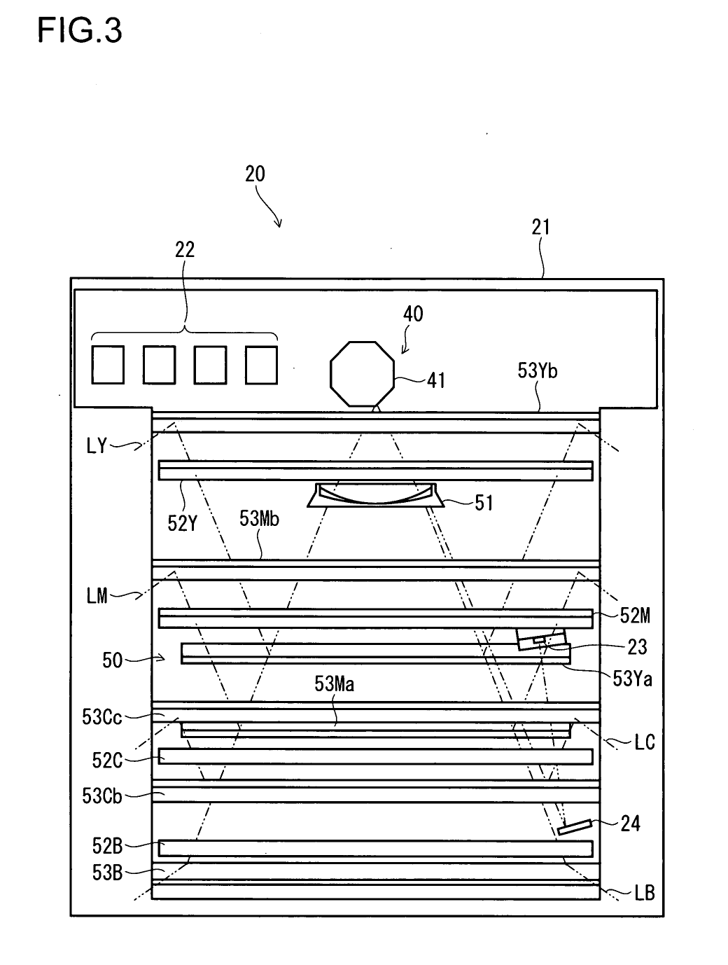

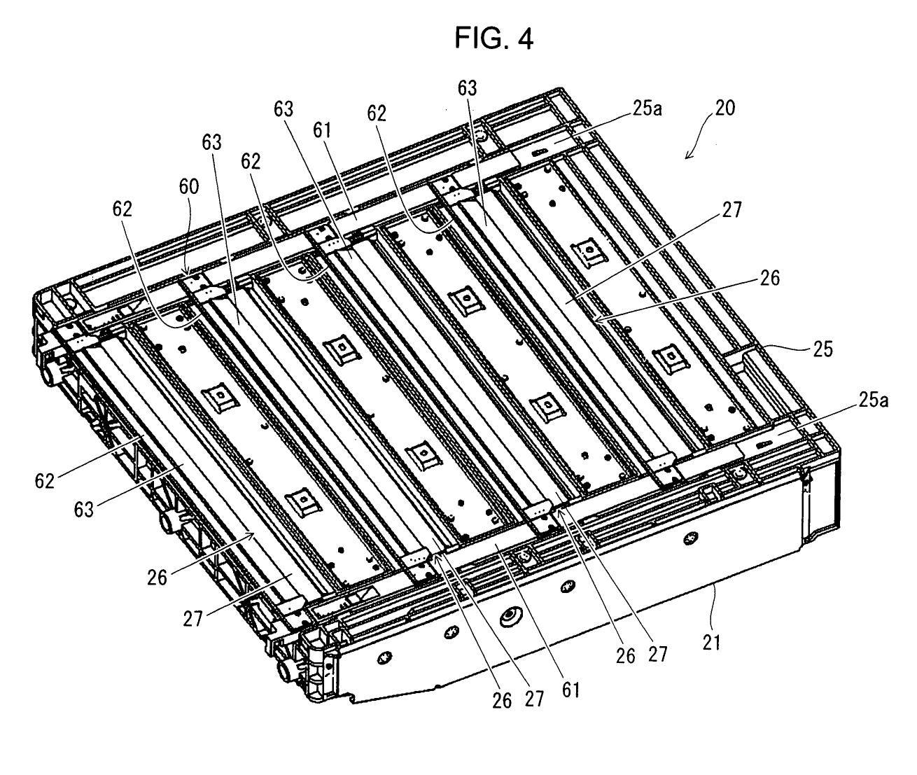

Now, with regard to the optical scanning device 20 provided in the image forming apparatus 1, an outline of the structure thereof will be described with reference to FIGS. 2 to 4. FIG. 2 is a schematic vertical sectional front view of the optical scanning device; FIG. 3 is a schematic top view of the optical scanning device; and FIG. 4 is a perspective view of the optical scanning device. Here, in FIGS. 2 and 3, the lid shown to be disposed at the top face of the optical scanning device in FIG. 4 is omitted from illustration.

As mentioned previously, the optical scanning device 20 is designed for incorporation in a tandem-type image forming apparatus 1 provided with four conductive drums corresponding to four different colors, namely yellow, magenta, cyan, and black.

As shown in FIGS. 2 and 3, the optical scanning device 20 has, housed inside a box-shaped housing 21, an optical arrangement composed of light sources 22, a light deflector 40, an optical system 50, and a photo sensor 23.

As shown in FIG. 3, the light sources 22 are disposed inside the housing 21, near one end thereof. For the optical scanning device 20 to cope with four colors, namely yellow, magenta, cyan, and black, there are provided four of the light sources 22 that are independent of one another. The light sources 22 are built with laser diodes that emit laser light in the visible range, for example laser light of a wavelength of about 670 nm in its specification.

Near the light sources 22, the light deflector 40 is disposed. The light deflector 40 is composed of a polygon mirror 41 and a motor 42. The motor 42 drives the polygon mirror 41, which has a polygonal shape as seen in a plan view, to rotate about the axis thereof, which is vertical as seen in FIG. 2. The polygon mirror 41, which thus rotates about the axis thereof, has a plurality of reflective surfaces around it on which it reflects light.

The respective laser beams LY, LM, LC, and LB emitted from the four light sources 22 are incident in the a scanning direction (in up and down direction in FIG. 2), with slight angular deviations among them, on the reflective surfaces around the polygon mirror 41. As the polygon mirror 41 rotates, it reflects the laser beams on one after another of the reflective surfaces thereof to direct them toward the opposite end of the housing 21 while deflecting them in the main scanning direction (in the right and left direction in FIG. 3).

The optical system 50 is disposed inside the housing 21, in an area through which the laser beams which is reflected from the light deflector 40 travels. The optical system 50 is composed of a first fθ lens 51, second fθ lenses 52, and reflecting mirrors 53.

The first fθ lens 51 is disposed at a place where the laser beams LY, LM, LC, and LB pass shortly after being reflected from the light deflector 40. There is provided only one of the first fθ lens 51 that is shared among the laser beams LY, LM, LC, and LB. The first fθ lens 51 deflects the laser beams LY, LM, LC, and LB at equal speeds in the main scanning direction. In addition, the first fθ lens 51 slightly widens the angles of the laser beams LY, LM, LC, and LB in the sub scanning direction while correcting factors that adversely affect scanning, such as the angles of incidence at which the laser beams LY, LM, LC, and LB are incident on the polygon mirror 41 and the slanting of the reflective surfaces of the polygon mirror 41.

Having passed through the first fθ lens 51, the laser beam for yellow LY is then reflected on a reflecting mirror 53Ya disposed near the inner bottom surface of the housing 21 back toward the first fθ lens 51. The laser beam LY then passes through a second fθ lens 52Y, is then reflected on a reflecting mirror 53Yb disposed near the top end of the housing 21, and then reaches, and is focused on, the surface of a conductive drum for yellow 31Y as the scanned surface.

Just like the laser beam for yellow LY, having passed through the first fθ lens 51, the laser beam for magenta LM is then reflected on a reflecting mirror 53Ma disposed near the inner bottom surface of the housing 21 back toward the first fθ lens 51. The laser beam LM then passes through a second fθ lens 52M, is then reflected on a reflecting mirror 53Mb disposed near the top end of the housing 21, and then reaches, and is focused on, the surface of a conductive drum for magenta 31M as the scanned surface.

Having passed through the first if lens 51, the laser beam for cyan LC is then reflected vertically upward on a reflecting mirror 53Ca disposed near the inner bottom surface of the housing 21, and is subsequently reflected substantially horizontally on a reflecting mirror 53Cb disposed near the top end of the housing 21. The laser beam LC then passes through a second fθ lens 52C, is then reflected on a reflecting mirror 53Cc, and then reaches, and is focused on, the surface of a conductive drum for cyan 31C as the scanned surface.

Having passed through the first fθ lens 51, the laser beam for black LB then directly, without being reflected on a reflecting mirror, passes through a second fθ lens 52B. The laser beam LB is then reflected on a reflecting mirror 53B, and then reaches, and is focused on, the surface of a conductive drum for black 31B as the scanned surface.

As shown in FIG. 3, the photo sensor 23 is disposed near the reflecting mirrors 53Ya and the second fθ lens 52M, slightly outward in the main scanning direction. The photo sensor 23 receives, of the laser beams reflected from the polygon mirror 41 of the light deflector 40, the parts which fall outside the effective exposure area on the scanned surfaces. The parts of the laser beams received by the photo sensor 23 are reflected toward it on a reflecting mirror 24 disposed near the second fθ lens 52B. The photo sensor 23 is a synchronism detection sensor for monitoring the timing of the scanning by the laser beams LY, LM, LC, and LB for the four colors, and is called a BD (beam detector) sensor.

As shown in FIG. 4, on the top face of the cabinet 2 having the optical arrangement described above housed inside it, a flat-plate-shaped lid 25 is provided. In the lid 25, openings 26 are formed through which the light beams, i.e. the laser beams LY, LM, LC, and LB, emitted from the optical arrangement pass when traveling toward the conductive drum surfaces. The openings 26 each have a rectangular shape extending in the main scanning direction, and there are provided four of them, one for each of the laser beams LY, LM, LC, and LB. Just as the four conductive drums 31 corresponding to the laser beams L are arranged side by side, the four openings 26 are arranged side by side.

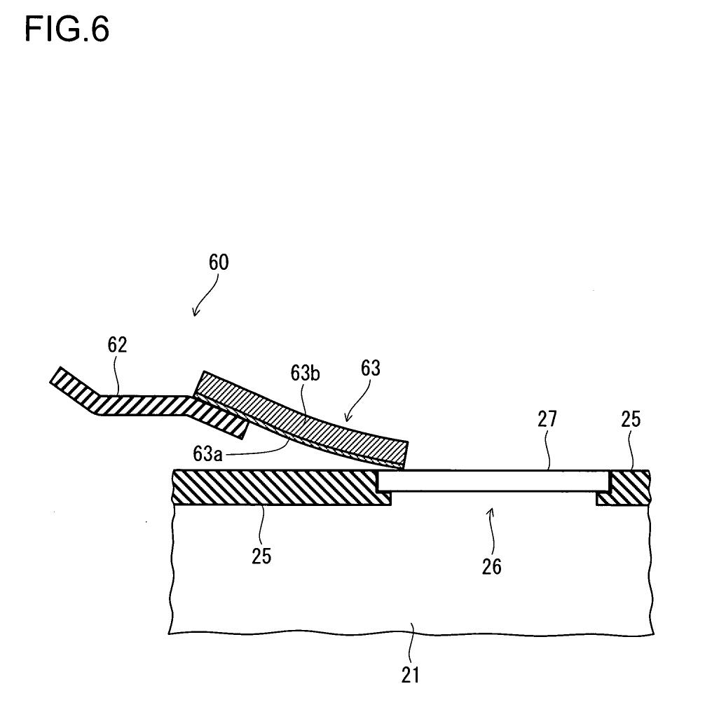

The four openings 26 are each provided with a dustproof glass plate 27. The dustproof glass plates 27, like the openings 26, each have a rectangular shape extending in the main scanning direction, and are so disposed as to close the openings 26 and thereby prevent dust such as scattered toner from entering the housing 21 through the openings 26 (see FIG. 6).

As shown in FIG. 4, on the top surface of the lid 25, a cleaning mechanism 60 for cleaning the dustproof glass plates 27 is provided.

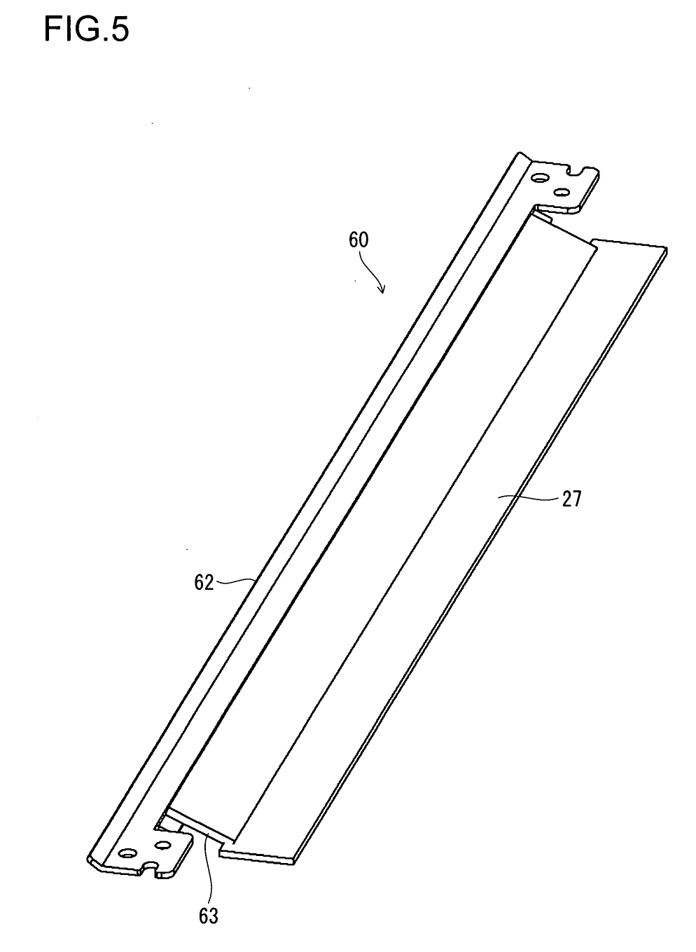

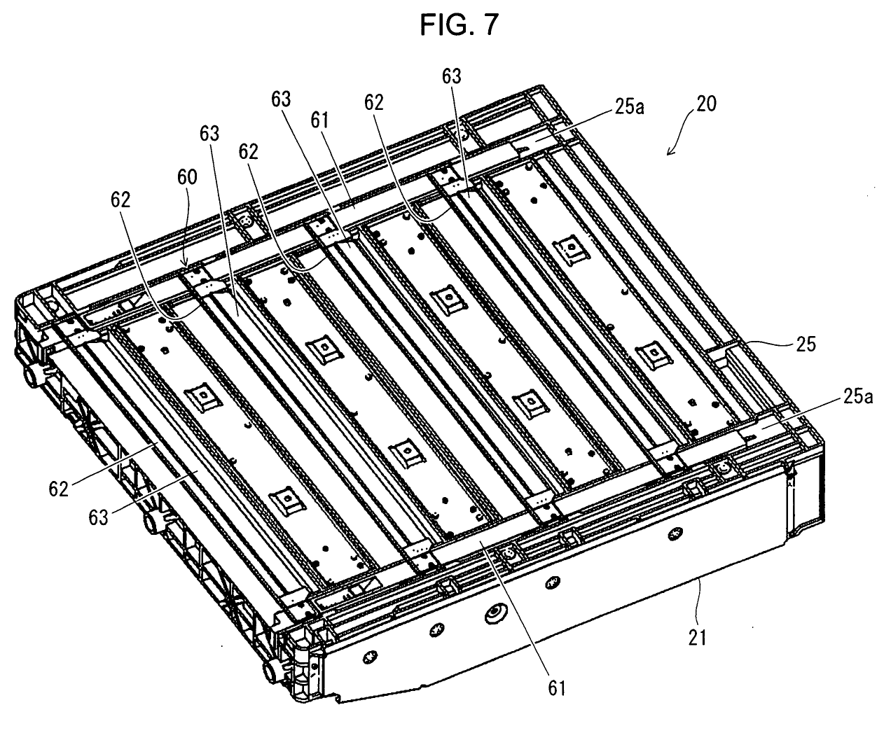

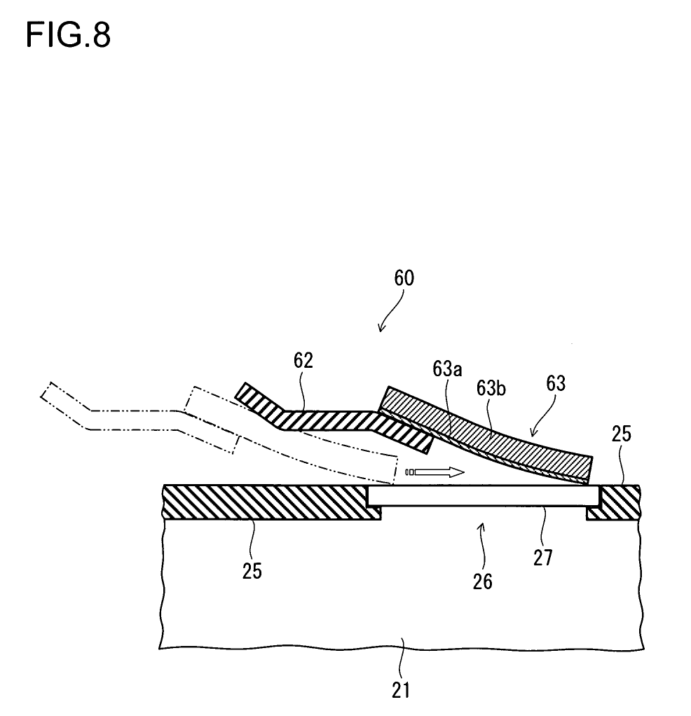

Now, the structure of the cleaning mechanism 60 for cleaning the dustproof glass plates 27 will be described in detail with reference to FIGS. 5 to 8 as well as FIG. 4. FIG. 5 is a perspective view of the elastic cleaning member provided in the cleaning mechanism and the surroundings thereof; FIG. 6 is a vertical sectional front view of the elastic cleaning member and the surroundings thereof; FIG. 7 is a perspective view, like FIG. 4, of the optical scanning device, to show the cleaning mechanism in action; and FIG. 8 is a vertical sectional front view, like FIG. 6, of the elastic cleaning member and the surroundings thereof, to show the cleaning mechanism in action.

As shown in FIG. 4, the cleaning mechanism 60 for cleaning the dustproof glass plates 27 is composed of slide members 61, support members 62, and cleaning blades 63 as elastic cleaning members.

The slide members 61 are rectangular members that extend like bars, and are disposed outside the dustproof glass plates 27 to extend in the direction in which the four dustproof glass plates 27 are arranged side by side. Two of the slide members 61 are provided, one at one ends of the dustproof glass plates 27 and the other at the other ends of the dustproof glass plates 27, both outside the dustproof glass plates 27. In the lid 25, grooves 25a are formed into which the slide members 61 just fit. The slide members 61 can slide along these grooves 25a in the direction in which the four dustproof glass plates 27 are arranged side by side.

The support members 62 are disposed between and coupled perpendicularly to the two slide members 61. Four of the support members 62 are provided, one for each of the four dustproof glass plates 27. The support members 62 are disposed above the lid 25, with a predetermined gap secured from the top surface of the lid 25 (see FIG. 6).

Four of the support members 62, as elastic cleaning members, are provided, each supported by one of the four support members 62. As shown in FIGS. 5 and 6, the cleaning blades 63 each have a rectangular shape extending in the main scanning direction along the dustproof glass plates 27, and are formed of polyurethane rubber. The cleaning blades 63 are fitted to extend obliquely downward from the support members 62 such that the cleaning blades 63 are, at the loose ends thereof, kept in pressed contact with the dustproof glass plates 27. Since the cleaning blades 63 are at the loose ends thereof kept in pressed contact with the dustproof glass plates 27, they remain in a bent state all the time.

As shown in FIG. 7, as the slide members 61 are slid along the grooves 25a in the lid 25, the cleaning blades 63 move together. Meanwhile, as shown in FIG. 8, the cleaning blades 63 wipe and thereby clean the surface of the dustproof glass plates 27 while being kept in pressed contact therewith.

Next, the structure of the cleaning blades 63 provided as elastic cleaning members in the cleaning mechanism 60 will be described in detail.

As described previously, the cleaning blades 63 each have a rectangular shape extending in the main scanning direction along the dustproof glass plates 27, and are formed of polyurethane rubber (see FIGS. 5 and 6). Moreover, the parts of the cleaning blades 63 that make contact with the dustproof glass plates 27 are formed of a material having a higher hardness than the material of which the parts of the dustproof glass plates 27 that do not make contact with the dustproof glass plates 27 are formed.

Specifically, as shown in FIG. 6, the cleaning blades 63 have a two-layer structure composed of a high-hardness portion 63a at which they make contact with the dustproof glass plates 27 and the remaining portion, called a low-hardness portion 63b, lying on top. Of the total thickness, 1.8 mm, of the cleaning blades 63, the high-hardness portion 63a accounts for 0.3 mm and the low-hardness portion 63b accounts for 1.5 mm. These portions are formed of different types of polyurethane rubber, the high-hardness portion 63a being formed of a type having a hardness of 99 Hs (JIS A), and the low-hardness portion 63b a type having a hardness of 65 Hs (JIS A). These two layers of polyurethane rubber are integrally put together in close contact so as not to come off or slide against each other.

On the other hand, the surface of the dustproof glass plates 27 at which they make contact with the cleaning blades 63 is coated with a coating film. The coating film on the surface of the dustproof glass plates 27 is formed of fluorocarbon resin or the like so that it is optically transparent, water-repellent, and oil-repellent and that it has a coefficient of friction of 0.5 or less against the cleaning blades 63.

The coefficient of friction of the coating film on the dustproof glass plates 27 against the cleaning blades 63 is determined in the following manner.

In a standard environment with a temperature of 20° C. and a humidity of 65%, a cleaning blade 63 is placed on a dustproof glass plate 27, and a weight having a mass of 200 g is placed further on top; then the cleaning blade 63 is pulled with a digital hanging scale. Meanwhile, it is checked whether the dustproof glass plate 27 and the cleaning blade 63 produce vibration between them and make noise. The test reveals that a coefficient of friction of 0.65 results in noise but that a coefficient of friction of 0.6 results in almost no noise. Accordingly, with a safer margin, the coating film on the dustproof glass plates 27 is given a coefficient of friction of 0.5 or less against the support members 62.

As described above, in an optical scanning device 20 provided with: an opening 26 through which a light beam traveling toward a scanned surface passes; a dustproof glass plate 27 serving as an optically transparent member that is provided at the opening 26; and a cleaning blade 63 serving as an elastic cleaning member that wipes the surface of the dustproof glass plate 27 while being kept in pressed contact therewith, the part of the cleaning blade 63 making contact with the dustproof glass plate 27 is formed of a material having a higher hardness than the material of which the part of the cleaning blade 63 not making contact with the dustproof glass plate 27 is formed. Thus, at the part of the cleaning blade 63 at which it makes contact with the dustproof glass plate 27, the former can be kept in satisfactorily pressed contact with the latter; in addition, the cleaning blade 63 can be kept in close contact with the surface of the dustproof glass plate 27 over the entire length of the former, i.e. over the entire range in the main scanning direction. This prevents uneven cleaning, and thus prevents dust such as scattered toner from remaining, making it possible to wipe the surface of the dustproof glass plate 27 effectively. It is also possible to prevent vibration during cleaning and thereby prevent various inconveniences induced by vibration. In this way, it is possible to realize an optical scanning device 20 that permits the surface of a dustproof glass plate 27 provided at an opening 26 through which a light beam passes to be cleaned with a cleaning blade 63 effectively without causing inconveniences such as noise and that offers high image quality.

Moreover, the elastic cleaning member is a cleaning blade 63, which is a blade that has a rectangular shape and that has a two-layer structure such that the part of the cleaning blade 63 a predetermined thickness deep from the surface at which it makes contact with the dustproof glass plate 27 is formed of a material having a higher hardness than the material of which the other part of the cleaning blade 63 is formed. This makes it comparatively easy to realize an elastic cleaning member that, at the part thereof making contact with the dustproof glass plate 27, can be kept in satisfactorily pressed contact with the dustproof glass plate 27 and that can be kept in close contact with the surface of the dustproof glass plate 27 over the entire range in the main scanning direction. Thus, in the cleaning of the surface of the dustproof glass plate 27, it is possible to achieve, with a simpler structure, prevention of inconveniences such as noise and effective cleaning free from uneven cleaning or remaining dust.

Furthermore, the dustproof glass plate 27 has, at the surface at which it makes contact with the cleaning blade 63, a coating film that is optically transparent, water-repellent, and oil-repellent and that provides a coefficient of friction of 0.5 or less. Thus, in addition to effective cleaning achieved with the cleaning blade 63, it is also possible to achieve prevention of moisture condensation on the surface of the dustproof glass plate 27. This helps to keep the surface of the dustproof glass plate 27 cleaner, and thus helps to obtain higher image quality. Besides these benefits, the coating film helps to suppress vibration, and permits the cleaning blade 63 to move smoothly across the surface of the dustproof glass plate 27. Thus, it is possible to achieve smooth cleaning while preventing inconveniences such as noise.

Moreover, according to the present invention, the optical scanning device 20 described above is incorporated in an image forming apparatus 1. This makes it possible to realize an image forming apparatus 1 that permits the surface of a dustproof glass plate 27 provided at an opening 26 through which a light beam from the optical scanning device 20 passes to be cleaned with a cleaning blade 63 effectively without causing inconveniences such as noise and that offers high image quality.

The embodiment by way of which the present invention has been described heretofore is in no way meant to limit the scope of the invention and, in practicing the invention, many modifications and variations are possible within its spirit.

For example, although the embodiment deals with, as an example, an optical scanning device designed for incorporation in a tandem-type image forming apparatus provided with four conductive drums, application of the present invention is not limited to such optical scanning devices; the invention may be applied to optical scanning devices for incorporation in other types of image forming apparatuses.

Although the embodiment deals with a case where the optically transparent member is formed of glass and the elastic cleaning member is formed of polyurethane rubber, their materials are not limited to those specifically mentioned; the optically transparent member and the elastic cleaning member may be formed of any other materials. The thickness and hardness of the high- and low-hardness portions 63a and 63b, which determine the shape of the cleaning blades 63, are not limited to the figures specifically given above, but may be varied within the spirit of the present invention.

The present invention is useful in an optical scanning device provided with: an opening through which a light beam traveling toward a scanned surface passes; an optically transparent member that is provided at the opening; and an elastic cleaning member that wipes the surface of the optically transparent member while being kept in pressed contact therewith.

What is claimed is:

1. an optical scanning device comprising:
a housing;
an optical arrangement housed inside the housing and irradiating a scanned surface with a light beam;
an opening through which the light beam from the optical arrangement travels toward the scanned surface;
an optically transparent member provided at the opening; and
an elastic cleaning member wiping a surface of the optically transparent member while being kept in pressed contact therewith, a part of the elastic cleaning member making contact with the optically transparent member being formed of a material having a higher hardness than a material of which a part of the elastic cleaning member not making contact with the optically transparent member is formed.

2. The optical scanning device according to claim 1, wherein the elastic cleaning member is a blade having a rectangular shape and having a two-layer structure such that a part of the elastic cleaning member a predetermined thickness deep from a surface at which the elastic cleaning member makes contact with the optically transparent member is formed of a material having a higher hardness than a material of which another part of the elastic cleaning member is formed.

3. The optical scanning device according to claim 1, wherein the optically transparent member has, at a surface at which the optically transparent member makes contact with the elastic cleaning member, a coating film that is optically transparent, water-repellent, and oil-repellent and that provides a coefficient of friction of 0.5 or less.

4. The optical scanning device according to claim 2, wherein the optically transparent member has, at a surface at which the optically transparent member makes contact with the elastic cleaning member, a coating film that is optically transparent, water-repellent, and oil-repellent and that provides a coefficient of friction of 0.5 or less.

5. An image forming apparatus comprising an optical scanning device, the optical scanning device comprising:
a housing;
an optical arrangement housed inside the housing and irradiating a scanned surface with a light beam;
an opening through which the light beam from the optical arrangement travels toward the scanned surface;
an optically transparent member provided at the opening; and
an elastic cleaning member wiping a surface of the optically transparent member while being kept in pressed contact therewith, a part of the elastic cleaning member making contact with the optically transparent member being formed of a material having a higher hardness than a material of which a part of the elastic cleaning member not making contact with the optically transparent member.

6. The image forming apparatus according to claim 5, wherein the elastic cleaning member is a blade having a rectangular shape and having a two-layer structure such that a part of the elastic cleaning member a predetermined thickness deep from a surface at which the elastic cleaning member makes contact with the optically transparent member is formed of a material having a higher hardness than a material of which another part of the elastic cleaning member is formed.

7. The image forming apparatus according to claim 5, wherein the optically transparent member has, at a surface at which the optically transparent member makes contact with the elastic cleaning member, a coating film that is optically transparent, water-repellent, and oil-repellent and that provides a coefficient of friction of 0.5 or less.
